(19) United States
(12) Patent Application Publication
(10) Pub. No.: US 2026/0039673 A1
(43) Pub. Date: Feb. 5, 2026

(54) TECHNIQUES FOR CONSTRAINT- AND RISK-BASED CYBERSECURITY INSPECTION IN CLOUD COMPUTING ENVIRONMENTS

(71) Applicant: Wiz, Inc., New York, NY (US)

(72) Inventors: Shahar RAND, Haifa (IL); Elad GABAY, Tel Aviv (IL); Eric ABRAMOV, Holon (IL); Yaniv SHAKED, Tel Aviv (IL); Ami LUTTWAK, Binyamina (IL); Yinon COSTICA, Tel Aviv (IL)

(73) Assignee: Wiz, Inc., New York, NY (US)

(21) Appl. No.: 18/792,211

(22) Filed: Aug. 1, 2024

(51) Int. Cl. H04L 9/40

(52) U.S. Cl. CPC H04L 63/1425; H04L 63/1416; H04L 63/1441

(57) ABSTRACT

A method for inspecting a computing environment for cybersecurity issues based on constraints, is presented. The method includes detecting a plurality of entities deployed in a computing environment; inspecting each entity of the plurality of entities for a cybersecurity object, wherein the cybersecurity object indicates a cybersecurity issue; generating an inspection plan based on a result of inspecting each entity of the plurality of entities; inspecting the computing environment based on the inspection plan; and initiating a remediation action in response to detecting the cybersecurity object.

### TECHNICAL FIELD

The present disclosure relates generally to cybersecurity, and specifically to optimizing resource deployment and risk detection based on scanning.

### BACKGROUND

Cloud computing environments, such as Amazon® Web Services (AWS), supply many advantages, such as scale, cost efficiency, fast resource deployment, and so on. However, these advantages come at a cost, namely that in order to be useful a cloud computing environment must be accessible from an external network. The same external networks pose an opportunity for bad actors, attackers, and the like, to attempt to gain access to these cloud computing environments.

Additionally, some cloud computing environments become large and therefore impractical for humans to manage. As a result, administrators in charge of managing such cloud computing environments may not be completely aware of the contents of the cloud computing environments, including cloud entities such as resources and principals.

In order to overcome at least these problems, certain solutions provide cloud computing scanning capabilities. For example, network scanning may be used to discover workloads (i.e., resources) in the cloud computing environment, and various scanning techniques allow to discover what such workloads contain, such as vulnerabilities.

Current solutions to cloud workload vulnerability scanning require the deployment of specialized tools, including scanning agents directed to the maintenance of virtual machines (VMs), where operation and maintenance of such tools may be costly, time-consuming, or both. Agent-dependent processes are more complex to deploy and maintain for scanning of containers, such as containers managed using Kubernetes®, and others, like, container-management platforms, and may fail to provide for coverage of serverless applications. Where such agent-implementation processes fail to provide for full cloud workload vulnerability scanning, additional methods, such as snapshot-based scanning, may supplement implemented solutions.

Snapshot-based scanning, wherein static “snapshots” of processes, services, data, and the like, are analyzed in an environment separate from the source environment, provides agentless scanning. Snapshot-based scanning is applied in various fields, including computer forensics, to provide for analysis of services, processes, data, and the like, in locations or environments other than those from which the snapshots are collected, as retrospective analysis. However, the applicability of snapshot-based scanning is limited in multi-tenant systems, such as shared cloud platforms, as cloud tenants may desire high levels of data protection during snapshot generation, transfer, and analysis.

Further, snapshot-based scanning methods, as well as hybrid methods including both agent-implemented and snapshot-based methods, may be inapplicable to certain cloud system structures and environments. For example, scanners may be configured only for processing certain types of workloads, and not others. This would require multiple solutions, e.g., separate analysis of container repositories, VM snapshots, and application programming interfaces (API) for serverless applications, where existing solutions fail to provide such integrated functionality.

Scanning a cloud computing environment is therefore resource intensive. For example, processors and memory need to be dedicated to the scanning process, all of which have an associated cost of use.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a system and method for resource deployment in a cloud computing environment based on cybersecurity inspection.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include detecting a plurality of entities deployed in a computing environment. Method may also include inspecting each entity of the plurality of entities for a cybersecurity object, where the cybersecurity object indicates a cybersecurity issue. Method may furthermore include generating an inspection plan based on a result of inspecting each entity of the plurality of entities. Method may in addition include inspecting the computing environment based on the inspection plan. Method may moreover include initiating a remediation action in response to detecting the cybersecurity object. Other embodiments of this aspect include corresponding computer systems, apparatus, and computer programs recorded on one or more computer storage devices, each configured to perform the actions of the methods.

Implementations may include one or more of the following features. Method may include: generating the inspection plan based on a cybersecurity risk detecting during a first inspection of the computing environment. Method may include: generating the inspection plan to inspect a resource of a first type at a first frequency; and generating the inspection plan to inspect a resource of a second type at a second frequency. Method may include: inspecting each entity of the plurality of entities for a plurality of cybersecurity objects. Method may include: generating the inspection plan to inspect a portion of the entities of the plurality of entities for a portion of the plurality of cybersecurity objects at a first time; and generating the inspection plan to inspect each entity of the plurality of entities for each cybersecurity object of the plurality of cybersecurity objects at a second time. Method may include: generating the inspection plan based on a resource constraint. Method where the resource constraint is based on any one of: processor utilization, storage utilization, network bandwidth utilization, and any combination thereof. Method may include: generating a representation of the computing environment in a security database; associating a representation of each entity of the plurality of entities with a representation of a detected cybersecurity object in the security database; and store a result of the initiated inspection in the security database, where the result relates to an entity of the plurality of entities. Method may include: generating the inspection plan based on a cybersecurity risk constraint and a resource constraint. Implementations of the described techniques may include hardware, a method or process, or a computer tangible medium.

In one general aspect, non-transitory computer-readable medium may include one or more instructions that, when executed by one or more processors of a device, cause the device to: detect a plurality of entities deployed in a computing environment. Medium may furthermore inspect each entity of the plurality of entities for a cybersecurity object, where the cybersecurity object indicates a cybersecurity issue. Medium may in addition generate an inspection plan based on a result of inspecting each entity of the plurality of entities. Medium may moreover inspect the computing environment based on the inspection plan. Medium may also initiate a remediation action in response to detecting the cybersecurity object. Other embodiments of this aspect include corresponding computer systems, apparatus, and computer programs recorded on one or more computer storage devices, each configured to perform the actions of the methods.

In one general aspect, system may include one or more processors configured to: detect a plurality of entities deployed in a computing environment. System may furthermore inspect each entity of the plurality of entities for a cybersecurity object, where the cybersecurity object indicates a cybersecurity issue. System may in addition generate an inspection plan based on a result of inspecting each entity of the plurality of entities. System may moreover inspect the computing environment based on the inspection plan. System may also initiate a remediation action in response to detecting the cybersecurity object. Other embodiments of this aspect include corresponding computer systems, apparatus, and computer programs recorded on one or more computer storage devices, each configured to perform the actions of the methods.

Implementations may include one or more of the following features. System where the one or more processors are further configured to: generate the inspection plan based on a cybersecurity risk detecting during a first inspection of the computing environment. System where the one or more processors are further configured to: generate the inspection plan to inspect a resource of a first type at a first frequency; and generate the inspection plan to inspect a resource of a second type at a second frequency. System where the one or more processors are further configured to: inspect each entity of the plurality of entities for a plurality of cybersecurity objects. System where the one or more processors are further configured to: generate the inspection plan to inspect a portion of the entities of the plurality of entities for a portion of the plurality of cybersecurity objects at a first time; and generate the inspection plan to inspect each entity of the plurality of entities for each cybersecurity object of the plurality of cybersecurity objects at a second time. System where the one or more processors are further configured to: generate the inspection plan based on a resource constraint. System where the resource constraint is based on any one of: processor utilization, storage utilization, network bandwidth utilization, and any combination thereof. System where the one or more processors are further configured to: generate a representation of the computing environment in a security database; associate a representation of each entity of the plurality of entities with a representation of a detected cybersecurity object in the security database; and store a result of the initiated inspection in the security database, where the result relates to an entity of the plurality of entities. System where the one or more processors are further configured to: generate the inspection plan based on a cybersecurity risk constraint and a resource constraint. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example of a network diagram showing a cloud computing environment and an inspection environment utilized to describe the various disclosed embodiments.

FIG. 2 is an example of a security graph representing a cloud computing environment, utilized to describe an embodiment.

FIG. 3 is an example of a flowchart of a method for reducing compute resources when performing an inspection of workloads in a cloud computing environment, implemented in accordance with an embodiment.

FIG. 4 is an example flowchart for optimizing resource deployment in a cloud computing environment, implemented in accordance with an embodiment.

FIG. 5 is an example flowchart of a method for generating an inspection plan for inspecting a computing environment, implemented in accordance with an embodiment.

FIG. 6 is an example schematic diagram of an inspection controller according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

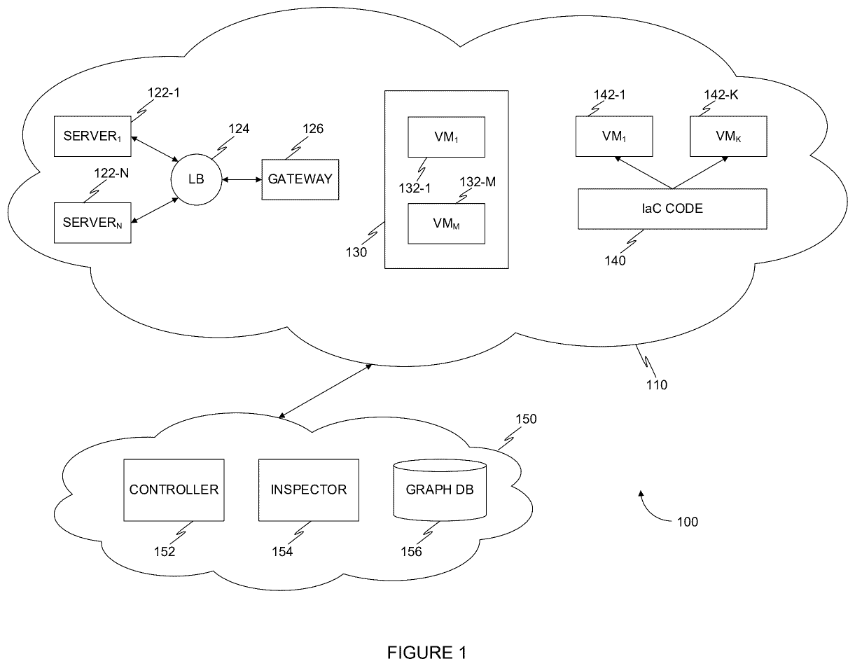

FIG. 1 is an example of a network diagram 100 showing a cloud computing environment and an inspection environment utilized to describe the various disclosed embodiments. The cloud computing environment 110 includes a plurality of cloud entities, such as resources and principals. A resource is a cloud entity that may be a workload, implemented, for example, as a virtual machine (VM), container engine, serverless function, and the like. A VM may be deployed, for example, through an Oracle® VirtualBox® hypervisor. A container engine may be, for example, a Docker® engine, Kubernetes® engine, and the like. A serverless function may be, for example, Amazon® Lambda.

A principal is a cloud entity that may be, for example, a user account, a service account, a role, and the like. In an embodiment, the cloud computing environment 110 is deployed as a virtual private cloud (VPC) on a cloud computing infrastructure. A cloud computing infrastructure may be, for example, Amazon® Web Services (AWS), Google® Cloud Platform (GCP), Microsoft® Azure, Oracle®, Oracle® Cloud Infrastructure (OCI), and the like.

The cloud computing environment 110 includes a plurality of web servers 122-1 through 122-N, referred to collectively as web servers 122, where ‘N’ is an integer having a value of ‘2’ or greater. In an embodiment, the web servers 122 are deployed as virtual machines (VMs). The web servers 122 are connected to a load balancer (LB) 124, which in turn is connected to a gateway 126. In an embodiment, the load balancer 124 is deployed as an application load balancer on a container, virtual machine, or the like. The load balancer provides resources stored on the web servers 122 to a client, which communicates with a web server of the web servers 122 through the gateway 126. The gateway 126 provides connectivity between an external network, such as the Internet, and the cloud computing environment 110.

The cloud computing environment 110 further includes an instance group 130. In an embodiment, an instance group 130 is a user-defined group of managed virtual instances, such as VM 132-1 through VM 132-M, collectively referred to as VMs 132, where ‘M’ is an integer number having a value of ‘2’ or greater. While VMs 132 are used for this example, it should be understood that an instance group 130 may include any type of virtual instance, such as containers and serverless functions, which for control purposes, are treated as a single entity. For example, in a GCP a managed instance group (MIG) is a group of VMs that are managed as though they are a single entity. An instruction sent to one VM of the group of VMs is sent to all the VMs of the group. This is useful, for example, when utilizing a large number of similar instances, which may be deployed for purposes of load balancing, redundancy, and the like. In an embodiment, each instance group 130 contains a single type of virtual workload.

The cloud computing environment 110 also includes a plurality of VMs 142-1 through 142-K, referred to collectively as VMs 142, where ‘K’ is an integer having a value of ‘2’ or greater. Each VM of the plurality of VMs 142 is generated based on a code object from an infrastructure as code (IaC) code 140. In an embodiment, the IaC code 140 is sent to an orchestrator (not shown), which deploys cloud entities in the cloud computing environment 110 based on declaratory code in the IaC code 140. An orchestrator may be, for example, Terraform®. In an embodiment, a state file used by the orchestrator may be used to determine what cloud entities are deployed based on code objects of the IaC code 140, and generate groups of cloud entities (such as the plurality of VMs 142), where each cloud entity in a group is based on the same code object.

The cloud computing environment 110 is connected to an inspection environment 150. In an embodiment, the inspection environment 150 is implemented as a cloud computing environment, such as a VPC, and may share a cloud infrastructure with the cloud computing environment 110. The inspection environment 150 includes a controller 152, an inspector 154, and a graph database 156, for storing therein a security graph.

The controller 152 is a workload that controls inspectors, such as inspector 154. The controller 152 is configured to determine what workloads in the cloud computing environment 110 should be inspected, for example, to detect vulnerabilities. The controller 152 may be deployed, for example, as a node in a container. The controller 152 is discussed in more detail below.

The inspector 154 is a workload which is configured to detect at least one object in an inspected workload. For example, a snapshot may be generated of a disk associated with a virtual machine in the cloud computing environment 110. A volume is generated based on the snapshot and access is provided to the inspector 154, for example, by generating a persistent volume claim (PVC) to the generated volume. In an embodiment, the inspector 154 is configured to search the volume for any one of: a file, a secret, a hash, a certificate, an application, an operating system, a user account, application code, and the like. In certain embodiments, the inspector 154 is deployed as a node in a container.

The graph database 156 is configured to store therein a security graph. In an embodiment, the security graph stores a representation of the cloud computing environment 110. For example, cloud entities, such as resources and principals, may be stored in the security graph as nodes, connected by edges which indicate the type of connection between the nodes. In certain embodiments, the security graph includes a data schema. The data schema may specify data types for various entities. For example, a principal may have a data type of a first kind, while a resource may have a data type of a second kind. In some embodiments, the security graph may be utilized to generate instance groups. For example, an IaC code object may be represented as a node in the security graph, which is connected to a plurality of virtual instance nodes, each of which is deployed based on the IaC code object. By querying the security graph to determine which nodes are connected to the IaC code object node, it is possible to determine which virtual instances deployed in the cloud environment may be grouped together. Grouping together instances is beneficial, for example, in utilizing the methods described in more detail herein.

As another example, the load balancer 124 may be represented as a load balancer node in the security graph, connected to a plurality of server nodes, each representing a server of the servers 122. In an embodiment, the security graph is queried to detect a load balancer node, and an output is generated. In certain embodiments, the output includes an identifier of a resource, represented in the security graph by a resource node which is connected to the load balancer node. The output may include a plurality of identifiers, each identifying a resource having a resource node connected to the load balancer node. In an embodiment, a controller 152 is configured to generate an inspection list based on an output of querying the security graph. In certain embodiments, the controller 152 is configured to configure inspectors, such as inspector 154, to inspect workloads based on the inspection list.

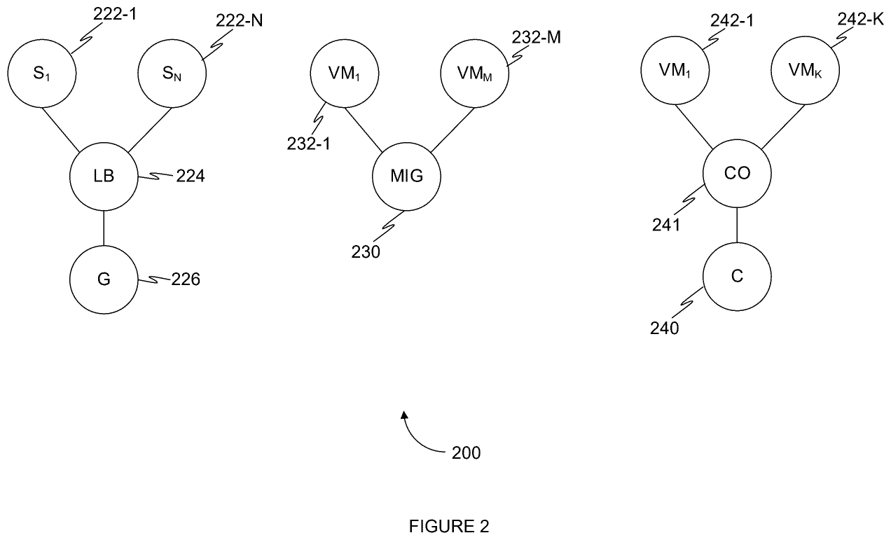

FIG. 2 is an example of a security graph 200 representing a cloud computing environment, utilized to describe an embodiment. The security graph 200 represents the cloud computing environment 110 of FIG. 1 above according to an embodiment. The security graph 200 may be stored in a graph database, such as graph database 156 of FIG. 1. A plurality of resource nodes 222-1 through 222-N, referred to collectively as resource nodes 222, represent each a corresponding web server of the plurality of web servers 122, such that resource node 222-1 represents web server 122-1, and so on. Each of the plurality of resource nodes 222 is connected to a load balancer resource node 224 representing the load balancer 124. The load balancer resource node 224 is connected to a gateway resource node 226, representing the gateway 126. In an embodiment, a resource node includes a data schema for storing information about a resource. Information may be, for example, an identifier, a resource type, and the like.

A second plurality of resource nodes 232-1 through 232-M, referred to collectively as second resource nodes 232, represent each a corresponding virtual machine (VM) of the plurality of VMs 132, such that resource node 232-1 represents VM 132-1, and so on. Each of the plurality of second resource nodes 232 is connected to a managed instance group node 230. In an embodiment, the managed instance group node 230 may be a resource type node.

A third plurality of resource nodes 242-1 to 242-K, referred to collectively as third resource nodes 242, represent each a corresponding virtual machine (VM) of the plurality of VMs 142, such that resource node 242-1 represents VM 142-1, and so on. Each of the plurality of third resource nodes 232 is connected to a code object (CO) node 241. The code object node 241 is connected to a code node 240. The code node 240 represents an IaC code, such as an IaC file. In an embodiment, the file may be, for example, a JSON file. The IaC code includes a plurality of code objects, and each may be represented in the security graph with a code object node, such as CO node 241.

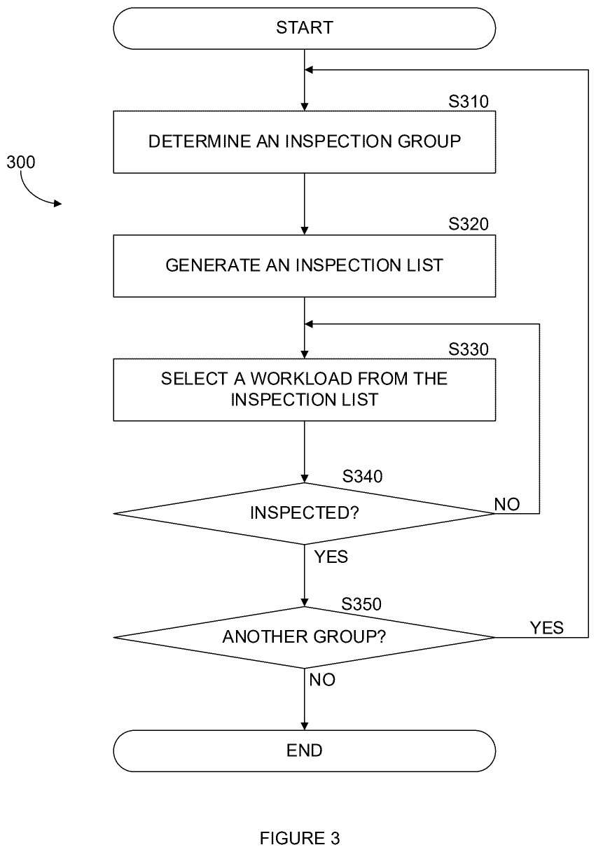

FIG. 3 is an example of a flowchart 300 of a method for reducing compute resources when performing an inspection of workloads in a cloud computing environment, implemented in accordance with an embodiment. Inspecting a subset of workloads of a group of similar workloads allows to reduce compute resources, specifically processing, memory, and storage resources. As the workloads are substantially identical, inspecting each and every one for vulnerabilities will not likely yield different results than inspecting only a subset of the workloads. A minimum of one workload from each group needs to be inspected. In an embodiment, the minimum number of inspected workloads is configurable. For example, the minimum number may be configured according to predefined rules, such as configuring the controller to inspect a minimum number of workloads from each group, the minimum number being any integer larger than zero and smaller than the number of workloads in the inspection group. In some embodiments, a rule may define a percentage of workloads which should be inspected (e.g., inspect 10% of the workloads in any group). In certain embodiments, a rule may specify that a workload group having a number of workloads above a first threshold and below a second threshold should have ‘N’ workloads inspected, where ‘N’ is an integer having a value of ‘1’ or more, but less than the number of workloads.

At S310, an inspection group is determined. An inspection group is a group of resources which are substantially identical, such that inspecting one resource of the inspection group for vulnerabilities is indicative of the other resources in the group having the same vulnerabilities. In an embodiment, determining an inspection group includes detecting identifiers for each of a group of resources, such as workloads, deployed in a cloud computing environment. In some embodiments, a security graph may be queried to determine an inspection group. The security graph includes a representation of the cloud computing environment. For example, the security graph may be queried to detect a node which indicates a connection to a group of similar nodes, such that the similar nodes, corresponding to similar resources, may be used to generate an inspection group. For example, the security graph may be queried to detect any one of: a node representing a load balancer, a node representing a managed instance group, a node representing a code object, and the like. For example, a load balancer node is connected to workload nodes which represent workloads (e.g., web servers) served by the load balancer. Thus, it can be assumed that each of these workloads is substantially identical such that only a subset of that group needs to be inspected to determine security risks for the entire group of workloads. A node representing a managed instance group is likewise connected to nodes representing each an instance which is substantially identical to the other instances in the managed instance group. A node representing a code object, or a base image, may be connected to a plurality of workloads which were deployed based on the code object, (or base image). The plurality of workloads is likewise substantially identical for the purpose of inspection.

In other embodiments, the security graph may be queried to detect nodes sharing similar or common attribute(s). For example, a resource node having data attributes which indicate that the resource node represents a workload of a first type (e.g., container), having an operating system (e.g., Linux®) with a certain version number, and the like. In an embodiment, the inspection group includes workloads which have at least one data attribute value in common.

At S320, an inspection list is generated. In an embodiment, the inspection list includes an identifier of a resource (i.e., workload) from the inspection group. In some embodiments, the inspection list includes a plurality of identifiers, each of a resource from a different inspection group. In yet other embodiments, the inspection list may include a subset of identifiers of resource of the inspection group.

For example, the inspection list may include a subset of identifiers, or all identifiers, ordered based on time of deployment. Thus, resources which are deployed for a longer time may be selected for inspection first. This may be beneficial in embodiments where the resources are continuously scaled up or down. Newer resources are likely recently spun up to meet demand and are therefore more likely to be spun down by the time inspection of the resource actually occurs. Ordering the inspection list by time of deployment, and selecting a resource for inspection based on the order therefore reduces the probability that a resource which is selected will be spun down by the time inspection actually occurs. In some embodiments, the inspection list is not ordered, but includes deployment times, and workloads may be selected from the inspection list (e.g., at S330) based on the included deployment times.

At S330, a workload is selected from the inspection list. In an embodiment, the first entry in the list is selected for inspection. In some embodiments, a workload is selected based on a time of deployment. An older workload may be inspected before another, more recently deployed (i.e., newer) workload is selected for inspection, for example as discussed above. In an embodiment, selecting a workload from the inspection list includes accessing a disk of the workload based on an identifier of the workload, the identifier extracted from the inspection list. A snapshot of the disk is generated, and a volume is mounted with the snapshot, providing access to an inspector workload to inspect the volume for data objects.

In some embodiments, the workload is selected based on a previous selection. For example, if a first workload of the inspection group was previously selected, the first workload may be selected again for inspection. This may be advantageous, for example, to detect changes over time in the deployment of the workload. Selecting each time, a random workload would not guarantee that such changes are detectable.

At S340, a check is performed to determine if the inspection of the selected workload was successful. If inspection was successful, execution may continue at S350. In some embodiments, where execution is not successful, execution may continue at S330, where another workload is selected from the inspection list. In certain embodiments, another workload is the next workload of an ordered inspection list, wherein the inspection list is ordered based at least on time of deployment.

In some embodiments, where inspection is successful, a node representing the inspected workload may be marked, for example, with a data indicator, to indicate that the resource represented by the node was previously inspected. As discussed above, this is advantageous in at least certain situations, where changes in a deployment over time (e.g., configuration drift) are to be detected. By providing an indicator in the security graph, the workload may be selected again next time an inspection is initiated. In some embodiments, the workload may not be available for inspection at the next inspection time. In such cases, the controller may select the next workload for inspection from the same inspection group based on the generated inspection list.

At S350, a check is performed to determine if another group should be inspected. If ‘yes’ execution may continue at S310, otherwise execution terminates.

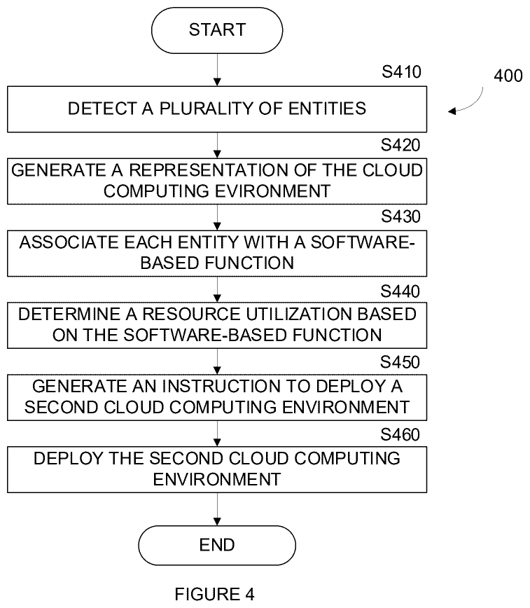

FIG. 4 is an example flowchart for optimizing resource deployment in a cloud computing environment, implemented in accordance with an embodiment.

At S410, a plurality of entities are detected. In an embodiment, the plurality of entities are detected in a cloud computing environment. In some embodiments, an entity is a resource, a principal, a combination thereof, and the like. In an embodiment, an entity is detected through network discovery, packet inspection, API querying, a combination thereof, and the like.

For example, in an embodiment, a resource is detected by querying an API of a cloud computing environment for a list of identifiers of resources deployed in the cloud computing environment. In an embodiment, the query includes an identifier of a cloud computing environment, such as a VPC identifier, a VPN identifier, an IP address, an IP address range, a subnet, a combination thereof, and the like.

At S420, a representation is generated. In an embodiment, the representation includes a representation of a cloud computing environment. In certain embodiments, a representation of the cloud computing environment includes a representation of a resource, a representation of a principal, a data schema, and the like.

In an embodiment, the representation is generated based on an inspection, a scan, and the like, of the cloud computing environment. In some embodiments, the representation is generated based on an inspection result of an inspector workload. In some embodiments, the detected resources are inspected for cybersecurity objects, software objects, and the like.

According to an embodiment, the representation is generated based on a unified database schema. In some embodiments, the representation is stored on a database, such as a security database. In an embodiment, the security database is implemented as a graph database, such as Node4j®.

In an embodiment, nodes in the representation represent resources, functions, principals, and the like, of the cloud computing environment. For example, in an embodiment, a load balancer is a function of a cloud computing environment. In some embodiments, a virtual machine is a resource of a cloud computing environment. In an embodiment, an inspector inspects a virtual machine (represented by a node in the representation) to detect an Nginx® software application executed thereon. In an embodiment, a representation of a load balancer, for which the Nginx software is utilized is included and connected to the representation of the virtual machine.

At S430, each entity is associated with a software-based function. In some embodiments, each entity of the plurality of entities is associated with a software-based function in the cloud computing environment. For example, in an embodiment, a resource, such as a virtual machine, a software container, a serverless function, and the like, are associated with a function, such as a load balancer, a gateway, a firewall, a web server, a software service, a combination thereof, and the like.

In an embodiment, a software-based function is detected utilizing static analysis of an inspectable disk generated based on a disk of a resource. In some embodiments, the function is detected based on data received from a sensor configured to listen on a data link layer of the resource. In certain embodiments, the function is detected based on a combination of static analysis and sensor data.

In some embodiments, the function is further detected based on inspection of an IaC code, a code object detected in a code repository, a combination thereof, and the like. For example, in an embodiment, a function is detected in a code object, such as a configuration authorizing a resource deployed based on the code object to access, for example, a bucket in a cloud computing environment.

At S440, a resource utilization is determined. In an embodiment, the resource utilization is based on the software-based function is determined. In another embodiment, a resource utilized based on the software-based function, the generated representation. etc.

In some embodiments, resource availability is detected by inspection. For example, in an embodiment, an API of a cloud computing environment is queried to detect resources provisioned to virtual resources. In some embodiments, the virtual resource is a virtual machine, while the provisioned resources are a processor, a memory, a storage, and the like, which are provisioned in order to deploy a virtual resource.

In an embodiment, a sensor is utilized to determine actual provisioned resource utilization. For example, in an embodiment, a sensor deployed on a workload, such as a virtual machine, is configured to detect resource utilization (e.g., how much of the resource is utilized per time unit).

In certain embodiments, the utilization of provisioned resources is stored, represented, associated, a combination thereof, and the like, in a representation of the virtual resource. For example, in an embodiment, the representation of a virtual machine includes a utilization of each provisioned resource (e.g., how much CPU is used, how much memory is used, etc.). In some embodiments, utilization is stored as aggregate values, such as average value. In certain embodiments, utilization is stored as minimal values, maximal values, a combination thereof, and the like.

At S450, an instruction to deploy a second cloud computing environment is generated. In some embodiments, an instruction to deploy a second cloud computing environment based on the software-based function and/or based on minimizing the determined resource utilization is generated.

At S460, a second cloud computing environment is deployed. In an embodiment, the second cloud computing environment is deployed in place of a cloud computing environment. In some embodiments, the second cloud computing environment is deployed in a test environment. In other embodiments, the cloud computing environment is replaced with a second cloud computing environment in response to determining that the second cloud computing environment provides a same functionality as the cloud computing environment.

In an embodiment, the second cloud computing environment is deployed in place of the cloud computing environment. In other embodiments, the second cloud computing environment is not deployed as a new cloud computing environment, but rather the first cloud computing environment is reconfigured into the second cloud computing environment.

According to some embodiments, deploying the second cloud computing environment is performed based on the determined resource utilization. In some embodiments, the resource utilization is optimized based on a detected software function. For example, in an embodiment, a virtual machine is provisioned a first processor, and inspection detects a load balancer application deployed on the virtual machine, which utilizes a maximum of 20% of the provisioned first processor.

In an embodiment, a second deployment includes deploying a virtual machine with a provisioned second processor which is less powerful (e.g., has less cores, less duty cycles, etc.) than the first processor. In some embodiments, the function a workload, resource, and the like, perform, is utilized in determining a provisioned resource.

Provisioning, re-provisioning, re-configuring, etc., a cloud computing environment based on an inspection result is advantageous as inspection which includes, for example, static analysis and run-time data provide a redeployment of a cloud computing environment which is based on actual resource utilization, and not based on theory or random provisioning of resources. Increasing utilization of resources reduces cost of deployment, for example, which is likewise advantageous.

In an embodiment, a code object is generated for the workload (e.g., the virtual machine of the example above) and utilized in declaration code of an infrastructure as code (IaC) platform. In some embodiments, the code object is stored in a code repository, version control system (VCS), a combination thereof, and the like.

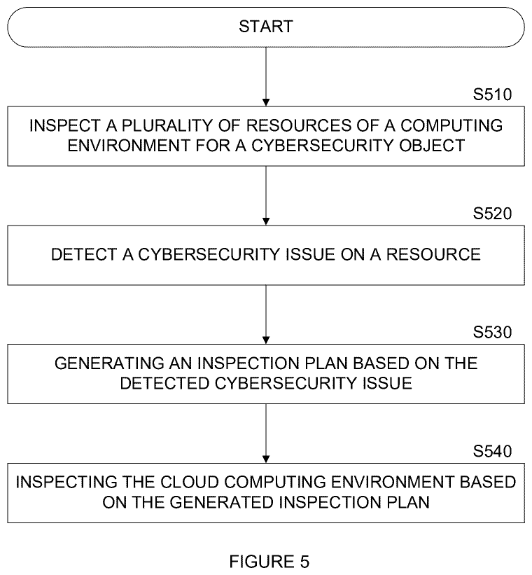

FIG. 5 is an example flowchart of a method for generating an inspection plan for inspecting a computing environment, implemented in accordance with an embodiment. In certain embodiments, an inspection controller is configured to generate an inspection plan. In some embodiments, an inspection plan includes a list of identifiers of resources which are inspected. In certain embodiments, the inspection plan further includes an indicator for an inspector which determines what resource is inspected and for which cybersecurity object the resource is inspected.

At S510, a plurality of resources are inspected. In an embodiment, a resource is inspected by detecting a disk associated with the resource (e.g., a volume associated with a virtual machine), and generating an inspectable disk based on the detected disk.

In some embodiments, the inspectable disk is generated by generating a cloned disk. In an embodiment, a cloned disk is generated by generating a cloned disk pointer, which points to a storage address.

In certain embodiments, a storage address is generated, for example, by dereferencing a pointer of the original disk. In an embodiment, a cloned disk is advantageous over a snapshot, for example, or other methods of copying a disk, as a clone is accessible immediately, while a snapshot needs to be fully copied (i.e., all data written to the copy) before it is accessible for inspection.

According to an embodiment, a resource is inspected for a cybersecurity object. In an embodiment, the resource is inspected for a plurality of cybersecurity objects. In some embodiments, a cybersecurity object, a plurality of cybersecurity objects, etc., indicate a cybersecurity issue. A cybersecurity issue is, for example, a cybersecurity risk, a misconfiguration, a vulnerability, an exposure, an exploitation, a combination thereof, and the like.

In an embodiment, a cybersecurity object is a code object, a malware object, a software signature, a hash value, a cryptographic key, a certificate, a password, a cleartext password, a software application, a software library, a software binary, an artificial intelligence (AI) model, a language model, a combination thereof, and the like.

In some embodiments, a result of inspection is stored, for example as a representation on a security database.

At S520, a cybersecurity issue is detected. In an embodiment, the cybersecurity issue is detected based on detection of a cybersecurity object which indicates the cybersecurity issue. In some embodiments, the cybersecurity issue is detected based on detecting a plurality of cybersecurity objects, in combination, on a resource, on a plurality of resources, etc.

For example, in an embodiment, a load balancer includes a misconfiguration (e.g., a fist cybersecurity object), and a server which is utilized by the load balancer includes sensitive data (e.g., a second cybersecurity object), and a cybersecurity risk is detected based on the first cybersecurity object and the second cybersecurity object.

At S530, an inspection plan is generated. In an embodiment, an inspection controller is configured to generate the inspection plan. In some embodiments, an inspection plan includes a list of resources to inspect, a type of inspection to initiate, a time to inspect, a constraint, a combination thereof, and the like.

In an embodiment, the inspection plan is generated based on a constraint, a plurality of constraints, and the like. In some embodiments, the constraint is a risk-based constraint. For example, in an embodiment, a risk-based constraint requires detecting the resources with the highest cybersecurity risk, and allocating a portion of inspection resources in a future inspection to inspecting resources having the highest cybersecurity risk.

In certain embodiments, this allocation allows to inspect the highest risk resources, thereby reducing a time an exploitation can be taken advantage of, in case of a cybersecurity attack.

According to an embodiment, the inspection plan is further generated based on a resource constraint. In an embodiment, a resource constraint relates to a processor utilization, network utilization, storage utilization, a combination thereof, and the like.

In an embodiment, an inspection plan is generated which includes multiple inspection plans. For example, in an embodiment, the inspection plan includes a first inspection plan having a first inspection frequency (e.g., resources are inspected every one week), and a second inspection plan having a second inspection frequency (e.g., resources are inspected every 24 hours).

In certain embodiments, the inspection plan is generated based on a resource constraint, a risk constraint, a combination thereof, and the like. For example, in an embodiment, resources having previously detected a cybersecurity issue thereon are inspected in a frequency which is higher than resources on which a cybersecurity issue is not previously detected.

In an embodiment, certain resource types are inspected in a frequency which is higher than a frequency at which a second type of resource is inspected. In some embodiments, a partial inspection (e.g., of a subset of resources) is performed daily, while a full inspection (e.g., of all resources) is performed weekly. In certain embodiments, a partial inspection includes only a portion of all resources deployed in a computing environment.

According to some embodiments, a partial inspection includes all resources, inspected only for a portion of cybersecurity objects. In an embodiment, partial inspection includes a sample of some resources, while a full inspection includes inspection of all resources.

At S540, inspection is initiated. In an embodiment, inspection is initiated by the inspection controller based on the generated inspection plan. In some embodiments, an inspection controller is received to continuously generate an updated inspection plan based on a result of a previous inspection.

For example, in certain embodiments, a first inspection detects a cybersecurity object on a first resource, and not on a second resource. In an embodiment, an inspection plan is then generated to include the first resource for the next inspection, but not the second resource. According to an embodiment, the inspection plan is then executed (i.e., inspection is initiated by the inspection controller) to inspect only the first resource. In some embodiments, a second inspection plan is then generated, to inspect both the first resource and the second resource, regardless of a result of the previous inspection.

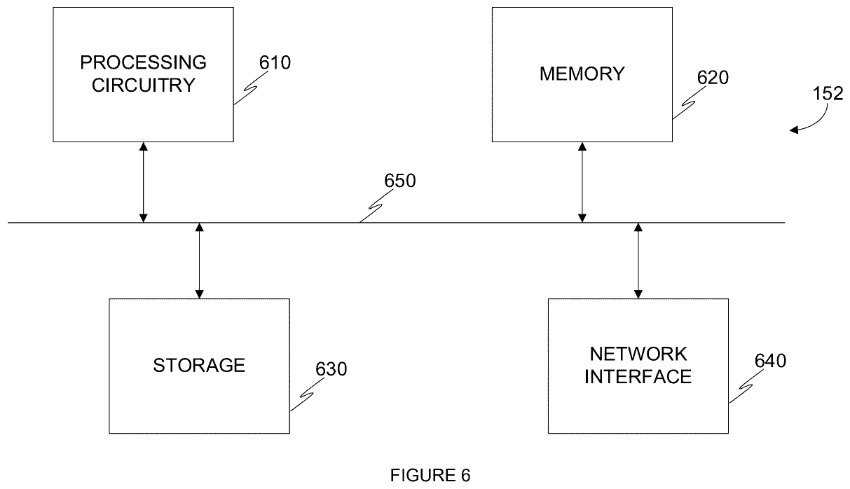

FIG. 6 is an example schematic diagram of an inspection controller (or simply ‘controller’) 152 according to an embodiment. The controller 152 includes a processing circuitry 610 coupled to a memory 620, a storage 630, and a network interface 640. In an embodiment, the components of the controller 152 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, or any other medium which can be used to store the desired information.

The network interface 640 allows the controller 152 to communicate with, for example, the inspector 154, and the graph database 156.

It should be understood that the embodiments described herein are not limited to the specific architecture illustrated in FIG. 6, and other architectures may be equally used without departing from the scope of the disclosed embodiments.

The disclosed embodiments provide a rule-based process for generating an inspection group of workloads, and from that group selecting a subset of workloads to be inspected. Inspecting the subset, rather than the entire group, of workloads allows reducing the amount of compute resources devoted to inspection. Generating an inspection group and selecting a subset of that group may be performed according to predefined rules. This is required in a cloud computing environment where virtual instances are constantly being spun up and down (i.e., starting an instance, and stopping an instance, respectively).

In this regard, it is noted that humans may define groups of workloads and select a subset of workloads from each group to inspect, but that these groups are not set or executed consistently because they are created and/or modified based on subjective opinions about what the groups “should” include and how they should select a subset of those groups. Even when an initial group is created using objective criteria, updates to the group are often made based on subjective evaluations of progress, and modifications to the group are further made based on subjective decisions, misread information, misunderstood information, and the like. For example, in a cloud computing environment where workloads are spun up and down in the thousands per hour, it would be impossible for a human, or a group of humans, to define a reliable inspection group, select a subset from that inspection group, and inspect that selected subset of workloads, before the inspection group, or portions thereof, are spun down.

As another example, a human may generate a group which contains workloads which are not similar enough to be grouped for inspection, but may appear similar at an initial glance. For example, Windows®-based virtual machines may appear similar at an initial glance, but can be further categorized based on operating system version, installed applications, underlying hypervisor, and the like.

Consequently, any attempts to establish routines through which groups are generated and subsets are selected either fail or are successful by chance. Thus, the manual process for generating inspection groups and cannot be effectively automated.

The disclosed embodiments avoid this inconsistent generation of inspection groups and selection of a subset of workloads from each inspection group by utilizing objective rules for generating inspection groups and selecting subsets thereof, rather than only based on subjective user intentions. The result is that vulnerability inspections for cybersecurity threats are executed in a manner that is consistent while reducing only redundant inspection actions.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for inspecting a cloud computing environment for cybersecurity issues based on constraints, comprising:
detecting a plurality of entities deployed in a cloud computing environment;
inspecting each entity of the plurality of entities for a cybersecurity object, wherein the cybersecurity object indicates a cybersecurity issue;
generating an inspection plan based on a result of inspecting each entity of the plurality of entities, wherein the result includes detecting a cybersecurity object on at least an entity of the plurality of entities;
inspecting the cloud computing environment based on the inspection plan to detect the cybersecurity object; and
initiating a remediation action in the cloud computing environment in response to detecting the cybersecurity object on the at least an entity of the cloud computing environment, wherein the remediation action resolves the cybersecurity issue.

2. The method of claim 1, further comprising:
generating the inspection plan based on a cybersecurity risk detecting during a first inspection of the cloud computing environment.

3. The method of claim 1, further comprising:
generating the inspection plan to inspect a resource of a first type at a first frequency; and
generating the inspection plan to inspect a resource of a second type at a second frequency.

4. The method of claim 1, further comprising:
inspecting each entity of the plurality of entities for a plurality of cybersecurity objects.

5. The method of claim 4, further comprising:
generating the inspection plan to inspect a portion of the entities of the plurality of entities for a portion of the plurality of cybersecurity objects at a first time; and
generating the inspection plan to inspect each entity of the plurality of entities for each cybersecurity object of the plurality of cybersecurity objects at a second time.

6. The method of claim 1, further comprising:
generating the inspection plan based on a resource constraint.

7. The method of claim 6, wherein the resource constraint is based on any one of: processor utilization, storage utilization, network bandwidth utilization, and any combination thereof.

8. The method of claim 1, further comprising:
generating a representation of the cloud computing environment in a security database;
associating a representation of each entity of the plurality of entities with a representation of a detected cybersecurity object in the security database; and
storing a result of the inspection of the cloud computing environment, based on the inspection plan, in the security database, wherein the result relates to an entity of the plurality of entities.

9. The method of claim 1, further comprising:
generating the inspection plan based on a cybersecurity risk constraint and a resource constraint.

10. A non-transitory computer-readable medium storing a set of instructions for inspecting a cloud computing environment for cybersecurity issues based on constraints, the set of instructions comprising:
one or more instructions that, when executed by one or more processing circuitries of a device, cause the device to:
detect a plurality of entities deployed in a cloud computing environment;
inspect each entity of the plurality of entities for a cybersecurity object, wherein the cybersecurity object indicates a cybersecurity issue;
generate an inspection plan based on a result of inspecting each entity of the plurality of entities, wherein the result includes detecting a cybersecurity object on at least an entity of the plurality of entities;
inspect the cloud computing environment based on the inspection plan to detect the cybersecurity object; and
initiate a remediation action in response to detecting the cybersecurity object.

11. A system for inspecting a cloud computing environment for cybersecurity issues based on constraints comprising:
one or more processing circuitries configured to:
detect a plurality of entities deployed in a cloud computing environment;
inspect each entity of the plurality of entities for a cybersecurity object, wherein the cybersecurity object indicates a cybersecurity issue;
generate an inspection plan based on a result of inspecting each entity of the plurality of entities;
inspect the cloud computing environment based on the inspection plan; and
initiate a remediation action in the cloud computing environment in response to detecting the cybersecurity object on the at least an entity of the cloud computing environment, wherein the remediation action resolves the cybersecurity issue.

12. The system of claim 11, wherein the one or more processing circuitries are further configured to:
generate the inspection plan based on a cybersecurity risk detecting during a first inspection of the cloud computing environment.

13. The system of claim 11, wherein the one or more processing circuitries are further configured to:
generate the inspection plan to inspect a resource of a first type at a first frequency; and
generate the inspection plan to inspect a resource of a second type at a second frequency.

14. The system of claim 11, wherein the one or more processing circuitries are further configured to:
inspect each entity of the plurality of entities for a plurality of cybersecurity objects.

15. The system of claim 14, wherein the one or more processing circuitries are further configured to:
generate the inspection plan to inspect a portion of the entities of the plurality of entities for a portion of the plurality of cybersecurity objects at a first time; and
generate the inspection plan to inspect each entity of the plurality of entities for each cybersecurity object of the plurality of cybersecurity objects at a second time.

16. The system of claim 11, wherein the one or more processing circuitries are further configured to:
generate the inspection plan based on a resource constraint.

17. The system of claim 16, wherein the resource constraint is based on any one of:
processor utilization, storage utilization, network bandwidth utilization, and any combination thereof.

18. The system of claim 11, wherein the one or more processing circuitries are further configured to:
generate a representation of the cloud computing environment in a security database;
associate a representation of each entity of the plurality of entities with a representation of a detected cybersecurity object in the security database; and
store a result of the inspection in the security database, wherein the result relates to an entity of the plurality of entities.

19. The system of claim 11, wherein the one or more processing circuitries are further configured to:
generate the inspection plan based on a cybersecurity risk constraint and a resource constraint.

20. The method of claim 1, wherein the cloud computing environment is deployed on a cloud computing infrastructure.
